(19) United States
(12) Patent Application Publication
(10) Pub. No.: US 2014/0176426 A1
(43) Pub. Date: Jun. 26, 2014

(54) DISPLAY TERMINAL APPARATUS, INFORMATION DISPLAY SYSTEM, INFORMATION DISPLAY CONTROL METHOD AND STORAGE MEDIUM STORING PROGRAM THEREOF

(71) Applicant: CASIO COMPUTER CO., LTD., Tokyo (JP)

(72) Inventor: Hiroshi MOROHOSHI, Tokorozawa-shi (JP)

(73) Assignee: CASIO COMPUTER CO., LTD., Tokyo (JP)

(21) Appl. No.: 14/105,586

(22) Filed: Dec. 13, 2013

(30) Foreign Application Priority Data
Dec. 20, 2012 (JP) 2012-277617

(51) Int. Cl. G06F 3/01

(52) U.S. Cl. CPC G06F 3/01
USPC 345/156

(57) ABSTRACT

Disclosed is a display terminal apparatus including a wireless communication unit for performing wireless communication with a set external device, a display unit, a display information obtaining unit which obtains display information including a display content to be displayed in the display unit, a display period setting of the display content and a changing condition for changing the display period through the wireless communication unit, a display control unit which controls the display period of the display content in the display unit on the basis of the display period setting, a determination unit which determines whether a state corresponds to the changing condition, and a display period changing unit which changes the display period on the basis of a determination result obtained in the determination unit.

### CROSS-REFERENCE TO RELATED APPLICATION

The present U.S. patent application claims a priority under the Paris Convention of Japanese patent application No. 2012-277617 filed on Dec. 20, 2012 which shall be a basis of correction of an incorrect translation, and is incorporated by reference herein.

### BACKGROUND OF THE INVENTION

1. Field of the Invention

The present invention relates to a display terminal apparatus which displays information, an information display system, an information display control method and storage medium in which a program of the method is stored.

2. Description of the Related Art

Conventionally, there is known an information display system where data is transmitted between a plurality of information display terminals through wireless communication such as Bluetooth (registered trademark) communication and a needed message (display content) is displayed in a predetermined information display terminal at a predetermined timing as disclosed in JP 2001-167012 and JP 2005-234660.

In particular, in many cases, a user who uses a plurality of portable type information display terminals only use one of them according to the occasion. In such cases, by displaying information set in another information display terminal in the information display terminal which is the one being used, the information can be prevented from not being acknowledged by the user.

Among the messages to be displayed in such information display system, there is a message which is display at real time and deleted once a user performs deletion operation in the display terminal. Also, there is a message that can be displayed in an information display terminal during a certain display period, the display period being set in an information terminal which performed setting in the system.

The display information including a display period is sent to an information display terminal which displays the display information and the corresponding message.

Thereafter, even if the communication between the information terminal which performed setting and the information display terminal is cutoff, the message can be displayed in the information display terminal or deleted on the basis of the already obtained display information.

However, in the conventional display setting, once the display period of the display content is sent to the information display terminal as the display information, setting of the display period cannot be changed in a simple, manner even when circumstances change afterwards. Therefore, there is a problem that the display content cannot be display during a period of time desired by a user in a simple and flexible manner.

### SUMMARY OF THE INVENTION

An object of the present invention is to provide a display terminal apparatus, an information display system and in information display control method which enables to display a display content during a period of time desired by a user in a simple and flexible manner according to circumstances and a storage medium in which a program thereof is stored.

In order to achieve the above object, one aspect of the present invention is a display terminal apparatus including a wireless communication unit for performing wireless communication with a set external device, a display unit, a display information obtaining unit which obtains display information including a display content to be displayed in the display unit, a display period setting of the display content and a changing condition for changing the display period through the wireless communication unit, a display control unit which controls the display period of the display content in the display unit on the basis of the display period setting, a determination unit which determines whether a state corresponds to the changing condition, and a display period changing unit which changes the display period on the basis of a determination result obtained in the determination unit.

In order to achieve the above object, one aspect of the present invention is an information display system including a display terminal apparatus and an external device, and the display terminal apparatus includes a wireless communication unit for performing wireless communication with a set external device, a display unit, a display information obtaining unit which obtains display information including a display content to be displayed in the display unit, a display period setting of the display content and a changing condition for changing the display period through the wireless communication unit, a display control unit which controls the display period of the display content in the display unit on the basis of the display period setting, a determination unit which determines whether a state corresponds to the changing condition, and a display period changing unit which changes the display period on the basis of a determination result obtained in the determination unit, and the external device includes an external wireless communication unit for performing wireless communication with another external device, an external setting unit for setting display setup information including the display content to be displayed in the display terminal apparatus, the display period of the display content and the changing condition for changing the display period, an external storage unit in which the display setup information is stored for each display content, and a display information control unit which makes the external wireless communication unit send the display information relating to the display content to the display terminal apparatus at a predetermined timing with display start date and time of the display content being a reference.

In order to achieve the above object, one aspect of the present invention is an information display control method for displaying a display content obtained from a set external device in a display terminal apparatus including a wireless communication unit for performing wireless communication with the external device including obtaining display information including a display content to be displayed, a display period setting of the display content and a changing condition for changing the display period through the wireless communication unit, controlling the display period of the display content on a basis of the display period setting, determining whether a state corresponds to the changing condition and changing the display period on a basis of a determination result obtained in the determining.

In order to achieve the above object, a non-transitory computer readable storage medium storing a program which makes a computer used in a display terminal apparatus which displays a display content obtained from a set external device, the display terminal apparatus including a wireless communication unit for performing wireless communication with the external device, function as a display information obtaining unit which obtains display information including a display content to be displayed, a display period setting of the display content and a changing condition for changing the display period through the wireless communication unit, a display control unit which controls the display period of the display content on a basis of the display period setting, a determination unit which determines whether a state corresponds to the changing condition, and a display period changing unit which changes the display period on a basis of a determination result obtained in the determination unit.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 shows an entire view of an information display system according to an embodiment of the present invention;

FIG. 2 is a block diagram showing an inner configuration of an electronic time piece;

FIG. 3 is a block diagram showing an inner configuration of a smartphone;

FIGS. 4A, 4B and 4C are charts for explaining display information which is to be sent and received between a smartphone and an electronic time piece;

FIGS. 5A, 5B, 5C and 5D show display examples to be displayed in an electronic time piece;

FIGS. 6A, 6B, 6C and 6D show display examples to be displayed in an electronic time piece;

FIG. 7 is a flowchart showing a control procedure in a message receiving process;

FIG. 8 is a flowchart showing a control procedure in a display control process;

FIG. 9 is a flowchart showing the control procedure in the display control process;

FIG. 10 is a flowchart showing a control procedure in a message receiving process according to Embodiment 2;

FIG. 11 is a flowchart showing a control procedure in a display control process according to Embodiment 2;

FIG. 12 is a flowchart showing the continuation of the control procedure in the display control process according to Embodiment 2;

FIG. 13 is a block diagram showing an inner configuration of an electronic time piece according to Embodiment 3;

FIG. 14 is a flowchart showing a control procedure in a message receiving process according to Embodiment 3;

FIG. 15 is a flowchart showing a control procedure in a display control process according to Embodiment 3; and

FIG. 16 is a flowchart showing the continuation of the control procedure in the display control process according to Embodiment 3.

### DETAILED DESCRIPTION OF PREFERRED EMBODIMENTS

Hereinafter, embodiments of the present invention will be described with reference to the drawings.

### Embodiment 1

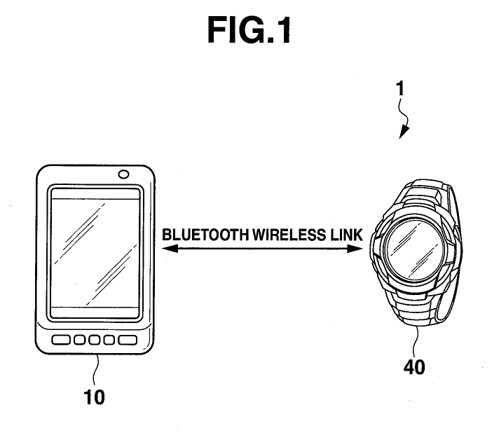

FIG. 1 is a diagram showing the entire information display system 1 according to Embodiment 1 of the present invention.

The information display system 1 includes a smartphone 10 as an external device and an electronic time piece 40 as a display terminal apparatus.

Bluetooth communication can be carried out between the smartphone 10 and the electronic time piece 40. Display data which is set in one of the smartphone, 10 and the electronic time piece 40 (here, the smartphone 10) can be displayed in the other thereof (here, the electronic time piece 40) during a set time period.

In the information display system 1, when the electronic time piece 40 and the smartphone 10 are operating within a communicatable range, it is set that the Bluetooth communication therebetween basically maintains to be connected at all times.

The electronic time piece 40 is a wrist watch type time piece provided with a band for wearing it around a use's wrist.

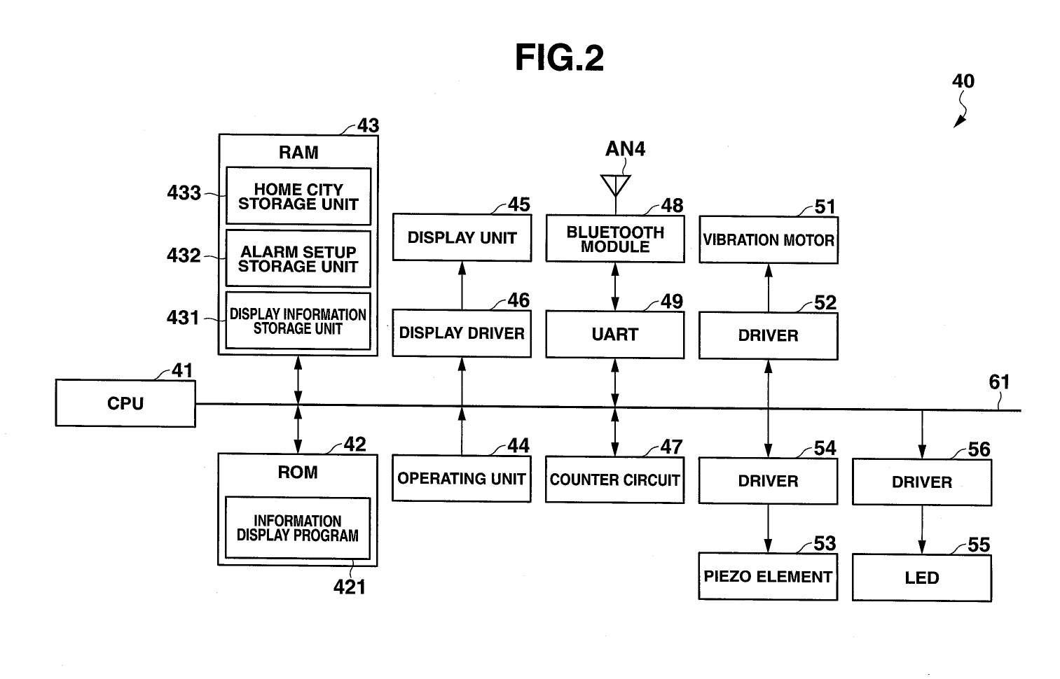

FIG. 2 is a block diagram showing an inner configuration of the electronic time piece 40.

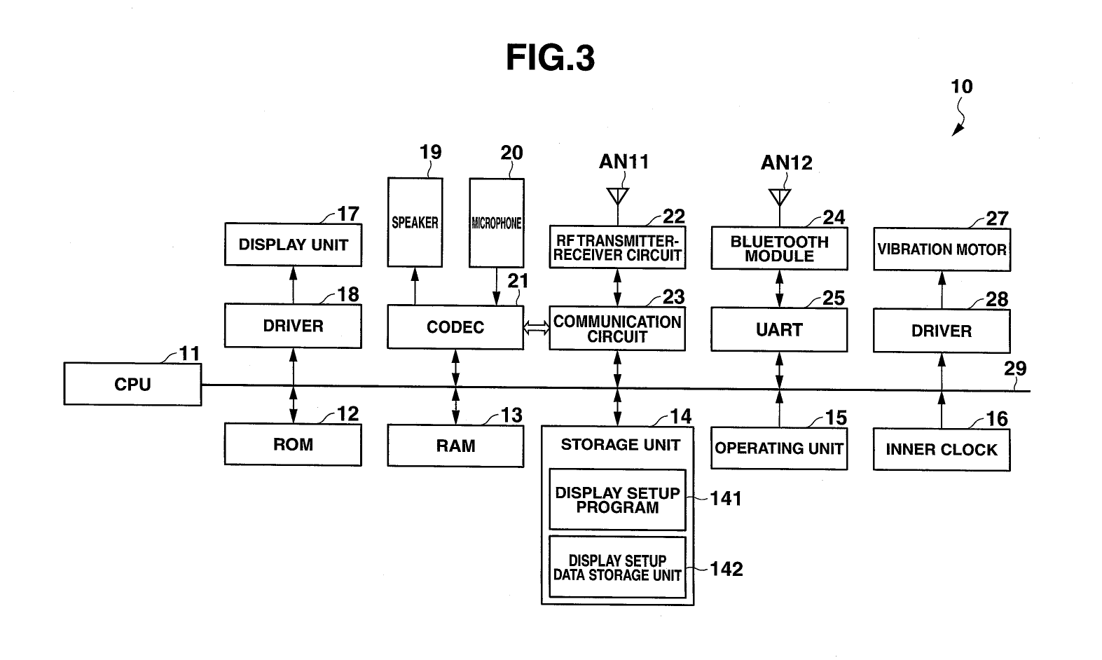

FIG. 3 is a block diagram showing an inner configuration of the smartphone 10.

As shown in FIG. 2, the electronic time piece 40 includes a CPU (Central Processing Unit) 41 (a display information obtaining unit, a display control unit, a determination unit, a display period changing unit), a ROM (Read Only Memory) 42, a RAM (Random Access Memory) 43, an operating unit 44 (operator), a display unit 45, a display driver 46 which drives the display unit 45, a counter circuit 47 (counter unit), an antenna AN4, a Bluetooth module 48 as a wireless communication unit, a UART (Universal Asynchronous Receiver Transmitter) 49, a vibration motor 51, a driver 52 for the vibration motor 51, a piezo element (PZT) 53, a driver 54 for the piezo element 53, a LED (light-emitting diode) 55, a driver for the LED 55, a bus 61 which performs sending and receiving of signals between the CPU 41 and each unit, etc.

The CPU 41 performs various arithmetic processing to integrally control the entire operation of the electronic time piece 40.

The CPU 41 makes the display unit 45 perform time display on the basis of the current time counted by the counter circuit 47.

Further, the CPU 41 makes the display unit 45 display a message regarding display information obtained from the smartphone 10 via the Bluetooth module 48 until a specified time limit.

This display operation will be described in detail later.

Along with such displaying, the CPU 41 can operate the vibration motor 51, the piezo element 53 or the LED 55.

In the ROM 42, various programs to be executed by the CPU 41 and initial setup data are stored.

In the data stored in the ROM 42, the information display program 421 (program) is included.

By the information display program 421 being executed by the CPU 41, display control of messages relating to various display information obtained from the smartphone 10 is carried out.

The RAM 43 provides the CPU 41 with a working memory space.

The RAM 43 includes a display information storage unit 431 (storage unit), an alarm setup storage unit 432 and a home city storage unit 433.

In the display information storage unit 431, a list of display information which the electronic time piece 40 received from the smartphone 10 is stored.

In the alarm setup storage unit 432, data relating to whether alarm notification operation is to be carried out or not and setting of alarm notification time is stored.

In the home city storage unit 433, setting of a city which is to be the reference for time display, that is, time difference information is stored.

The number of display information that can be stored in the list in the display information storage unit 431 is arbitrarily set. If the number of received display information exceeded the set number, the list is updated by overwriting old information with new information in a predetermined order excluding information which is not expired, for example.

The operating unit 44 includes four push button switches, here.

The operating unit 44 generates electric signals according to the push button switches a user operated on and outputs the generated electric signals to the CPU 11 as input signals.

Alternatively, the operating unit 44 may adopt other input operation method such as a method by including a crown and other switching switches or a method by including a touch detection unit such as a touch panel which is also used as a display unit 45.

The display unit 45 includes a LCD (liquid crystal display), for example.

The display driver 46 (liquid crystal driver) which operates according to a control signals sent from the CPU 41 drives the LCD and makes the LCD perform displaying relating to specified contents such as the current time, setup conditions of various functions and setup menu.

Alternatively, the display unit 45 may be a display configured with other display units such as an organic ELD (Electro-Luminescent Display), for example. The display driver 46 is selected arbitrarily according to the configuration of the display unit 45.

Although, the display unit 45 of the electronic time piece 40 according to this embodiment is not specifically limited, the display unit 45 includes a dot matrix type LCD and can display numbers, characters and various symbols such as in date and time.

Alternatively, as for the display screen of the display unit 45, other types of display screens such as an organic ELD (Electro-Luminescent Display) can be used.

The counter circuit 47 is a counter which keeps the current time by counting a predetermined frequency signal.

In the electronic time piece 40 according to this embodiment, the current time counted by the counter circuit 47 is date and time information including date.

In the electronic time piece 40, the current time is read from the counter circuit 47 by the CPU 41 and the current time is displayed in the display unit 45 and is used in various function operation.

In the electronic time piece 40 according to this embodiment, the current time counted by the counter circuited 47 may be synchronized and corrected through Bluetooth communication with the smartphone 10 at an arbitrary timing and also may be manually corrected through user's operation.

The Bluetooth module 48 is a control module for carrying out Bluetooth communication with the smartphone 10, which is an external device, via the antenna AN4.

Processing such as serial/parallel conversion and the like is performed on transmitting data which is sent from the CPU 41 by the UART 49 and the transmitting data is sent to the smartphone 10 from the Bluetooth module 48.

Moreover, processing such as serial/parallel conversion and the like is performed on incoming data, which is received by the antenna AN4 and the Bluetooth module 48 from the smartphone 10, by the UART 49 and the incoming data is output to the CPU 41.

The vibration motor 51, the piezo element 53 and the LED 55 are for performing notification operation with respect to a user through vibration, busser sound and light emission, respectively.

When the CPU 41 sends control signals to the drivers 52, 54 and 56, the drivers 52, 54 and 56 generate and output voltage signals required to operate the vibration motor 51, the piezo element 53 and the LED 55, respectively.

Here, the configuration for carrying out notification operation is not limited to the above example, and a miniature bulb, a miniature bell and the like may be used, for example.

As shown in FIG. 3, the smartphone 10 includes a CPU 11 (external setting unit, display information control unit), a ROM 12, a RAM 13, a storage unit 14, an operating unit 15, an internal clock 16, a display unit 17, a driver 18 for the display unit 17, a speaker 19, a microphone 20, a codec 21, a RF transmitter-receiver circuit 22 as the second communication unit, an antenna AN11 for sending and receiving through RF communication, a communication circuit 23, a Bluetooth module 24 as an external wireless communication unit, a UART 25, an antenna AN12 for sending and receiving through Bluetooth communication, a vibration motor 27, a driver 28 for the vibration motor 27, a bus 29 for connecting the CPU 11 and each unit, etc.

The CPU 11 performs various arithmetic processing and integrally controls the entire operation of the smartphone 10.

The CPU 11 controls operation relating to setting and editing of message contents to be displayed in the electronic time piece 40 and additional information such as display period of the message contents by using the operating unit 15 and the display unit 17.

Further, the CPU 11 sends control signals to the Bluetooth module 24 according to the list which is set in the setting and editing operation and which is stored in the display setup data storage unit 142, and the CPU 11 sends display information relating to messages to be displayed in the electronic time piece 40 to the electronic time piece 40.

In the ROM 12, various control programs to be executed by the CPU 11 and initial setup data are stored.

The RAM 13 is a volatile memory such as a SRAM and a DRAM, and the RAM 13 provides the CPU 11 with a working memory space. In the RAM 13, temporary data for working is stored.

The storage unit 14 is a data readable and writable non-volatile memory such as a flash memory and an EEPROM (Electrically Erasable and Programmable Read Only Memory), for example.

In the storage unit 14, the display setup program 141 and the display setup data storage unit 142 (external storage unit) are included.

The display setup program 141 is an application program for performing setting control of display operation which is to be performed in the electronic time piece 40.

The display setup program 141 may be a program exclusive for display data to be displayed in the electronic time piece 40 or may be a program which enables switching display between the smartphone 10 and the electronic time piece 40 by using a shared display data.

The display setup data storage unit 142 is a data table for storing a list of display setup information relating to messages to be displayed in the electronic time piece 40, the messages being set by using the display setup program 141.

Based on the display setup information stored in the display setup data storage unit 142, the CPU 11 sends display information including a message (display content) to be displayed in the electronic time piece 40, display time limit (display period setting) and additional information such as a condition for changing the display time limit to the electronic time piece 40 through Bluetooth communication at the timing of display start.

The operating unit 15 includes a plurality of operation keys and push button switches. The operating unit 15 generates electric signals according to operation performed by a user on the operation keys and push button switches and outputs the electric signals to the CPU 11 as input signals.

The operating unit 15 further includes a touch detection unit which detects touching and positions where touched on the display screen of the display unit 17.

The internal clock 16 is a counter which keeps the current time by counting.

In the smartphone 10 according to this embodiment, the current time counted by the internal clock 16 is date and time information including date.

In the smartphone 10, the current time is read out and displayed in the display unit 17 by the CPU 11.

Further, various operation are performed by the current time data and the set time data according to various functions being compared.

The current time data in the internal clock 16 is corrected by time data obtained as needed from a mobile base station when communicating with a mobile base station through the RF transmitter-receiver circuit 22.

The display unit 17 includes a LCD as a display screen, for example.

The driver 18 (liquid crystal driver) which operates by a control signal sent from the CPU 11 drives the LCD and makes the LCD perform display relating to various functions of the smartphone 10.

The display unit 17 may include a display screen of other display method such as an organic ELD (Electro-Luminescent Display), for example. The driver 18 is arbitrarily selected according to the display method.

The display unit 17 can function as a touch panel by displaying icons and buttons in the display screen of the display unit 17 and by associating the icons and the buttons with information corresponding to the touched positions detected by the touch detection unit of the operating unit 15 to receive input operations.

The speaker 19 converts electric signals into audio signals on the basis of the signals from the codec 21 and outputs audio.

The microphone 20 detects a sound wave, converts the detected sound wave into an electric signal and outputs the electric signal to the codec 21.

The codec 21 decodes a digital audio signal which is encoded and compressed and sends the decoded digital audio signal to the speaker 19 as an analog signal. The codec 21 also encodes the obtained audio signal and outputs the encoded audio signal to the CPU 11 and the communication circuit 23.

Here, a speaker for telephone call and a speaker for outputting audio outside may be provided separately.

The RF transmitter-receiver circuit 22 performs a sending and receiving process of telephone communication data and electronically transmitted message data (e-mails, SMS, text messages) between the smartphone 10 and a mobile base station using the antenna AN11.

The communication circuit 23 performs various types of processes on the incoming data and the transmitting data which are sent and received by the RF transmitter-receiver circuit 22 and performs passing of data between the communication circuit 23 and the CPU 11 or the codec 21.

The Bluetooth module 24 is a control module for performing Bluetooth communication with an external device, such as the electronic time piece 40, via the antenna AN12.

The transmitting data which is sent from the CPU 11 is subjected to processing such as serial/parallel conversion by the UART 25 and after the conversion, the transmitting data is sent to the electronic time piece 40 from the Bluetooth module 24.

Further, the incoming data from the electronic time piece 40 received through the antenna AN12 and the Bluetooth module 24 is subjected to processing such as serial/parallel conversion by the UART 25 and after the conversion, the incoming data is output to the CPU 11.

The vibration motor 27 is for performing notification to a user by generating vibration.

When a control signal is sent to the driver 28 from the CPU 11, the driver 28 generates a voltage signal needed for operating the vibration motor 27 and outputs the voltage signal to the vibration motor 27.

Next setting of display operation in the electronic time piece 40 will be described.

In the information display system 1 of this embodiment, display information required for display control in the electronic time piece 40, among the display setup information set in the smartphone 10, is sent to the electronic time piece 40 at the timing of display start.

A message (display content) relating to the display information is displayed on the display screen of the display unit 45 in the electronic time piece 40 until the timing of display end which is indicated by the set expiration timing (display period setting).

At this time, if a changing condition is fulfilled in the electronic time piece 40 according to the changing condition that is set as a part of the display setup information, the expiration timing is changed.

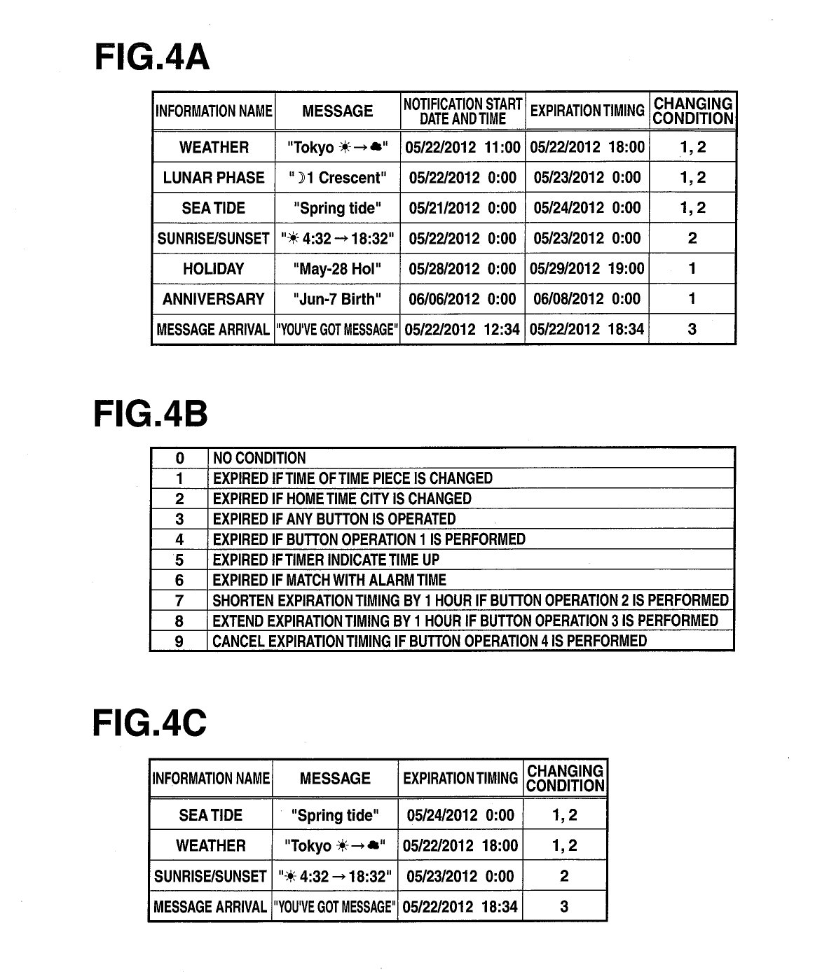

FIGS. 4A to 4C show charts for explaining display information which is sent and received between the smartphone 10 and the electronic time piece 40.

FIG. 4A is a chart showing an example of a data list of display setup information which is stored in the display setup data storage unit 142 of the smartphone 10.

As for display setup information stored in the smartphone 10 of this embodiment, information name, content of display message, date and time of display start, expiration timing (date and time of display end) and changing condition to change time limit are stored in an array so as to be associated to one another.

For example, with respect to the information name “weather” which is the first item in the list, it is set to display a message “Today's weather in Tokyo is sunny and later cloudy” during the time period between 11 a.m. to 18 p.m. on May 22, 2012.

In addition, here, information relating to regular changes such as lunar phase (or lunar age), sea tide, sunrise/sunset and the like, information relating to preset dates such as holidays and anniversaries to a user (schedule), information relating to matters that pops up on real time and randomly such as arrival information of electronically transmitted message data (e-mail, SMS, text message) to the smartphone 10 and the like are suggested an examples.

With respect to information which is set regularly, new messages are obtained by the display setup program 141 at set intervals and the display setting information is updated.

On the other hand, with respect to information to which being on real time is important, such as arrival information, the display setup program 141 is automatically activated at the time of arrival, the arrival time being set as the timing of display start and a predetermined duration is calculated starting this arrival time to automatically set the expiration timing.

Then, the display setup information is registered and stored in the display setup data storage unit 142 and is sent to the electronic time piece 40.

Here, a predetermined duration may be set to a different value according to the recipient, the sender of the electronically transmitted message data (e-mail SMS, text message) and the like.

FIG. 4B is a chart showing changing conditions included in the display setup information.

Changing conditions of expiration timing is not specifically limited. Here, numbers “0” to “9” and their corresponding contents are preset in the display setup program 141 and in the information display program 421. When setting a message to be displayed in the electronic time piece 40, a user of the smartphone 10 also sets a number that indicates the changing condition. The decided changing condition is stored in the display setup data storage unit 142.

At this time, a plurality of conditions may be selected and set with respect to one message as changing conditions.

Changing conditions include conditions for changing the expiration timing of a display to “expired” when it is determined that ongoing display is not appropriate due to indirect operation of a user and conditions for changing the expiration timing due to direct operation of a user.

For example, in a case where the city of home time is changed, it can be considered that a user moved to a different city. In such case, information relating to the original city, for example, weather forecast and sunrise/sunset, does not need to be displayed from here on.

On the other hand, according to a user's preference, sea tide information may not need to be displayed thereafter when a user came back from his/her fishing trip or the user may wish to have the previous day information be displayed longer, for example. In such case, the expiration timing of the display can be extended or shortened or the expiration timing can be canceled or changed to “expired” due to direct operation such as button operation.

FIG. 4C is a chart showing an example of a list of display information stored in the display information storage unit 431 of the electronic time piece 40.

These display information are contents relating to display control in the electronic time piece 40 which are sent from the smartphone 10 at the timing of information display start and at the timing of changing messages among the display setup information stored in the display setup data storage unit 142 of the smartphone 10.

In the electronic time piece 40 of this embodiment, information name, message content, expiration timing and changing condition are obtained from the smartphone 10 as display information and the display information is stored.

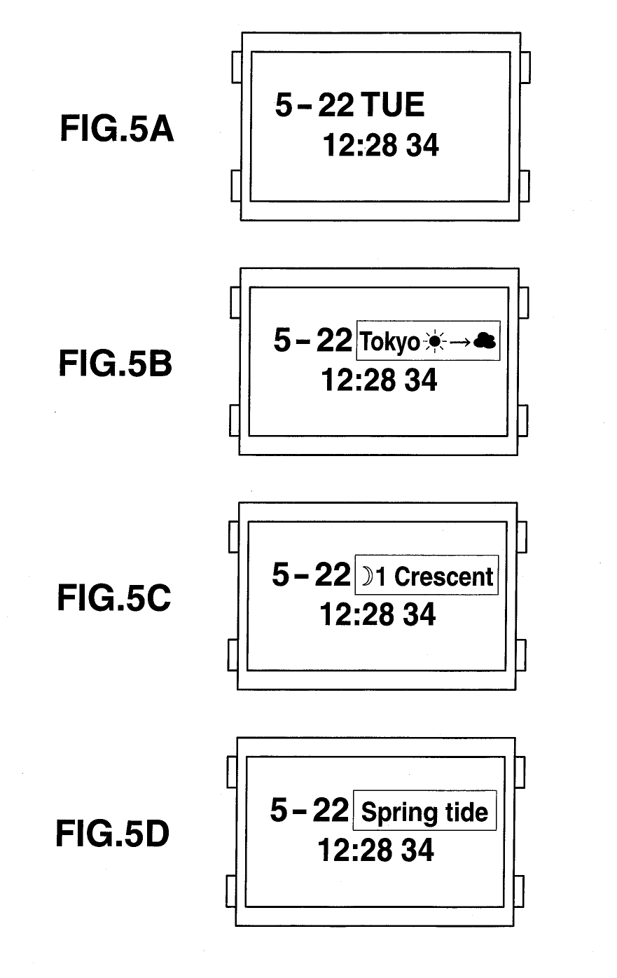

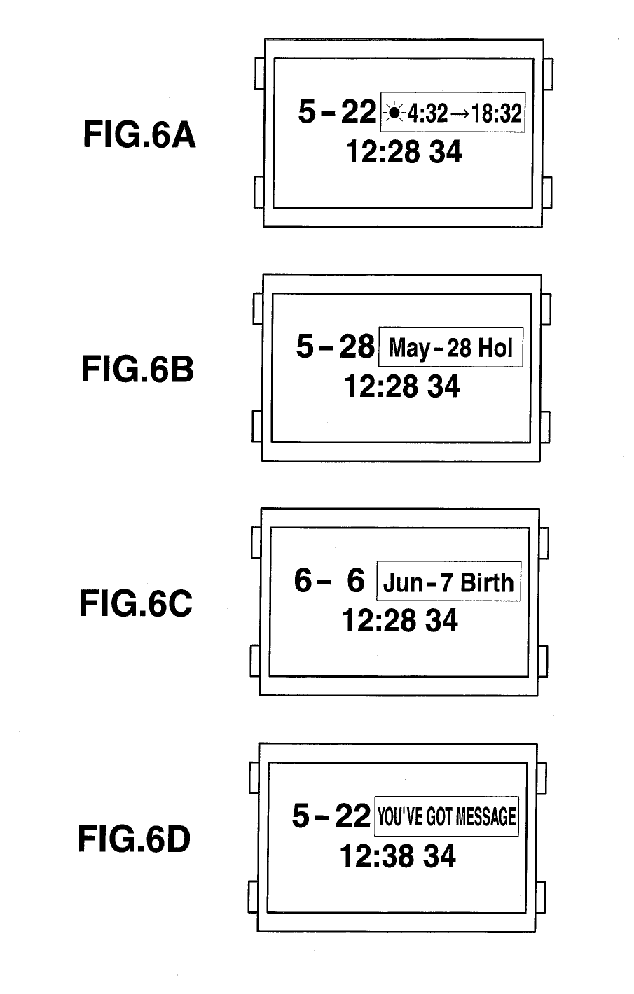

FIGS. 5A to 5D and FIGS. 6A to 6D show display examples in the display unit 45 of the electronic time piece 40.

FIG. 5A shows a display example in the display unit 45 in a normal display state of the current time.

In the electronic time piece 40, in the display state of the current time, date and day (here, May 22^{nd}, Tuesday) are displayed in the top line in the display screen of the display unit 45 and time (here, 12:28 34) is displayed in the lower line.

FIGS. 5B to 5D and FIGS. 6A to 6D are display examples when the seven display setting information shown in FIG. 4A are sent to the electronic time piece 40.

In the electronic time piece 40, a message content which is set is to be displayed in place of the display of the day in the top line in the display screen.

Although it is not specifically limited, a message is displayed by being emphasized by having a frame therearound, for example.

As shown in FIG. 5B, when weather forecast is to be displayed, Tokyo's weather forecast (sunny and later cloudy) is to be displayed as in the message set in FIG. 4A.

Similarly, when lunar phase is to be displayed, it is displayed that the moon is at lunar phase 1 as shown in FIG. 5C. Further, when sea tide is to be displayed, it is displayed that sea tide is currently in the period of spring tide as shown in FIG. 5D.

Further, when sunrise/sunset, holiday information, anniversary information and an indication of arrival of electronically transmitted message data (e-mail, SMS, text message) are to be displayed, displays such as “4:32→18:32” indicating the time during which the sun is out, “May 28, holiday”, “June 7, birthday” and “you've got message” are respectively displayed in the display screen in the display unit 45 as shown in FIGS. 6A to 6D.

Next, a procedure of message display operation in the electronic time piece 40 will be described.

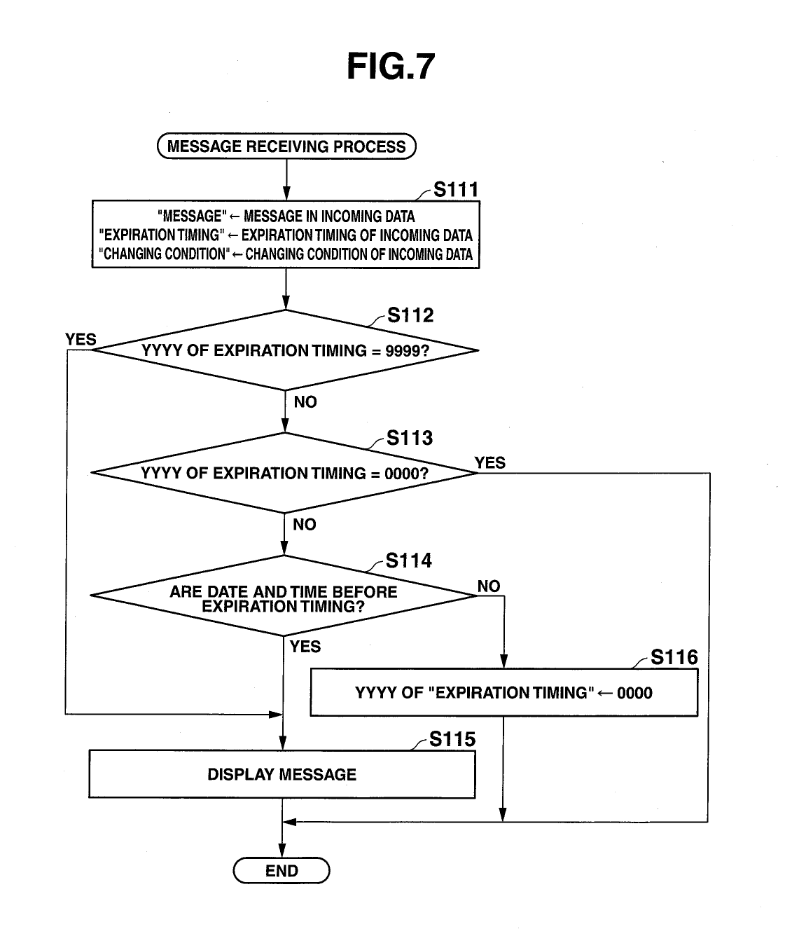

FIG. 7 is a flowchart showing a control procedure performed by the CPU 41 in a message receiving process executed in the electronic time piece 40.

The message receiving process starts by display information being received from the smartphone 10.

When the message receiving process starts, the CPU 41 first stores incoming data relating to the display information which the Bluetooth module 48 received in the display information storage unit 431 and obtains setups of a message, expiration timing and a changing condition as control variables (step S111).

Next, the CPU 41 determines whether the year display YYYY of the obtained expiration timing is “9999” which indicates that the expiration timing is not set (step S112).

If it is determined that the year display YYYY is “9999” (step S112; “YES”), processing of the CPU 41 proceeds to step S115.

If it is determined that the year display YYYY is not “9999” (step S112; “NO”), next, the CPU 41 determines whether the year display YYYY of the expiration timing is “0000” which indicates expiration (step S113).

If it is determined that the year display YYYY is “0000” (step S113; “YES”), the CPU 11 ends the message receiving process without displaying the message.

If it is determined that the year display YYYY is not “0000” (step S113; “NO”), the CPU 11 further determines whether the current date and time is before the expiration timing (step S114).

If it is determined that the current date and time is before the expiration timing (step S114; “YES”), processing of the CPU 41 proceeds to step S115.

If it is determined that the current data and time is not before the expiration timing (step S114; “NO”), the CPU 41 sets the year display YYYY of the expiration timing to “0000” to indicate expiration (step S116).

Then, the CPU 41 ends the message receiving process without displaying the message.

When processing proceeds to step S115 from step S112 or step S114, the CPU 41 outputs a control signal to the display driver 46 and displays the obtained message in the display screen of the display unit 45 (step S115).

Then, the CPU 41 ends the message receiving process.

In a case where a plurality of messages are before their expiration timing and it is difficult to display the plurality of messages in the display unit 45 at the same time, display pattern of these messages can be arbitrarily controlled before their expiration timing which exist parallelly.

For example, the CPU 41 can make the plurality of messages be displayed in a certain order.

In such case, according to the length of display duration, the length of remaining time until expiration and the like, display duration of each display and intervals between displays can be changed.

Further, a display indicating that there are a plurality of display target messages (for example, a display of “1/3” indicating that 1 message out of three display target messages is being displayed) can also be displayed.

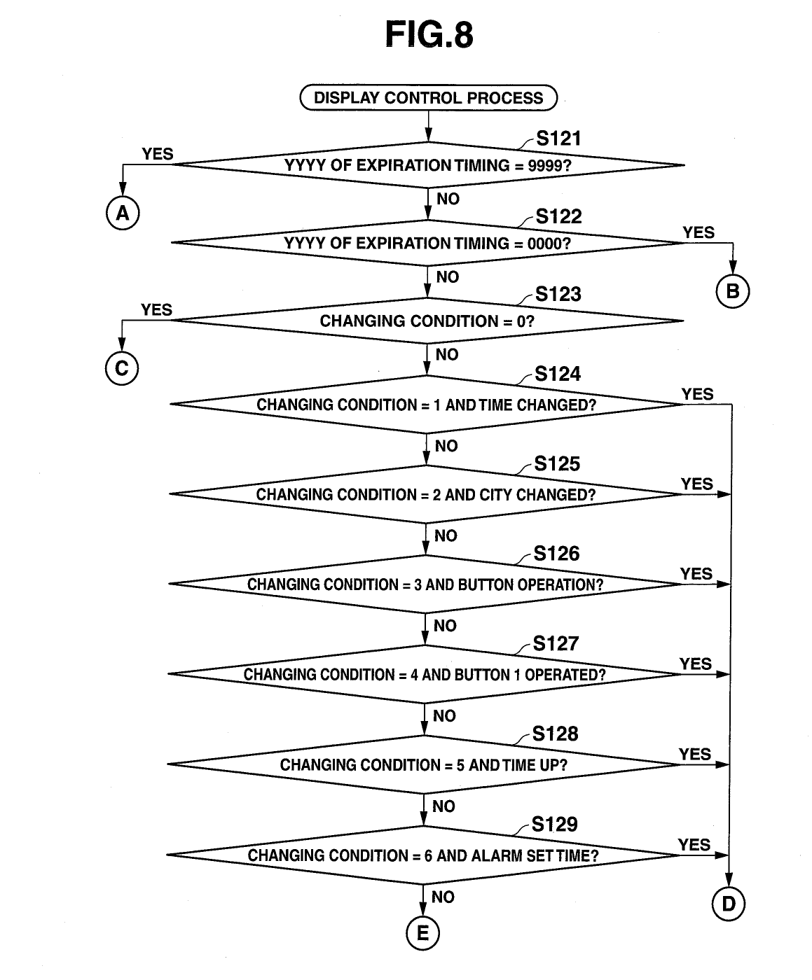

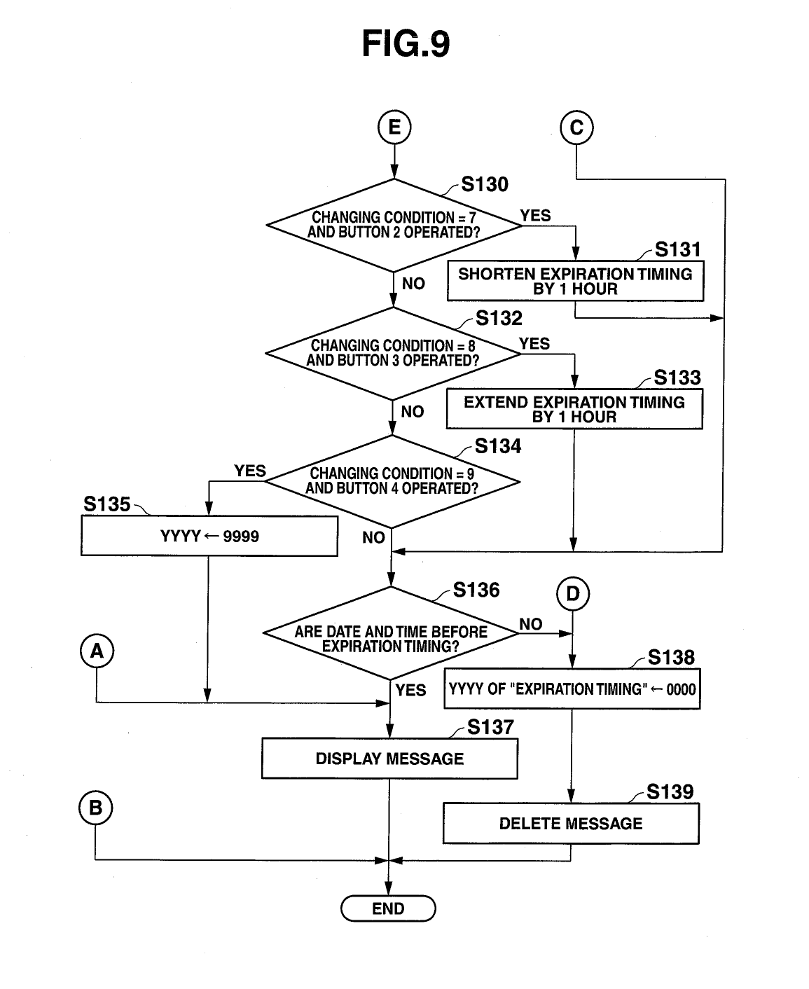

FIGS. 8 and 9 show a control procedure of a display control process which is executed by the CPU 41.

The display control process is repeatedly executed, in a regular manner, in a case where operation relating to changing condition is executed or an event relating to changing condition occurs and in a case where display information is stored in the display information storage unit 431.

When the display control process starts, the CPU 41 first determines whether the year display YYYY of the expiration timing is “9999” as shown in FIG. 8 (step S121).

If it is determined that the year display YYYY is “9999” (step S121; “YES”), processing of the CPU 41 proceeds to step S137.

If it is determined that the year display YYYY is not “9999” (step S121; “NO”), next, the CPU 41 determines whether the year display YYYY is “0000” (step S122).

If it is determined that the year display YYYY is “0000” (step S122; “YES”), the CPU 41 ends the display control process there.

The case where it is determined that the year display YYYY is “0000” in the determining process of step S122 is the case where display is not performed to begin with by following the arrow to “YES” in the process of step S116 in FIG. 7 or is the case where displaying is already canceled due to the expiration date being passed or due to “expired” being set. Therefore, in the electronic time piece 40 of this embodiment, the state of no display is maintained and the display control process ends.

If it is determined that the year display YYYY is not “0000” (step S122; “NO”), the CPU 41 determines whether the numerical value indicating a changing condition is “0” (step S123).

If it is determined that the numerical value is “0”, that is, if there is no changing condition (step S123; “YES”), processing of the CPU 41 proceeds to step S136.

If it is determined that the numerical value is not “0”, (step S123; “NO”), the CPU 41 determines whether the numerical value “1” is included in the changing condition and whether the time counted by the counter circuit 47 is corrected and changed (step S124).

If it is determined that the numerical value “1” is included in the changing condition and that the time counted by the counter circuit 47 is corrected and changed (step S124; “YES”), processing of the CPU 41 proceeds to step S138.

Here, as for the correction and changing of the time, the CPU 41 can determine that the time is corrected and changed if the correction amount of the time is more than the preset time period.

As described above, the smartphone 10 and the electronic time piece 40 are connected through Bluetooth communication basically at all times, and the electronic time piece 40 can be set to obtain time information from the smartphone 10 and correct and change the time as needed. However, such correction amount of time is usually smaller than one seconds.

Therefore, there is no need to cancel the display because of such minor correction.

In view of this, in the determination process of step S124, it can be set so as to determine that the correction and changing took place and to follow the arrow to “YES” only if the correction amount of the time is more than one hour, one hour being the set time, for example.

In a case where a minor correction is not to be performed, the set time may be 0 minute.

If it is determined that “1” is not included in the changing condition or if it is determined that the time counted by the counter circuit 47 is not changed (step S124; “NO”), the CPU 41 determines whether “2” is included in the changing condition and whether the home time city set and stored in the home city storage unit 433 is changed (step S125).

If it is determined that “2” is included in the changing condition and that the setting of home time city is changed (step S125; “YES”), processing of the CPU 41 proceeds to step S138.

If it is determined that “2” is not included in the changing condition or that the setting of home time city is not changed (step S125; “NO”), the CPU 41 determines whether “3” is included in the changing condition and whether an input signal according to operating of any one of the push button switches is input from the operating unit 44 (step S126).

If it is determined that “3” is included in the changing condition and that an input signal according to operating of any one of the push button switches is input from the operating unit 44 (step S126; “YES”), processing of CPU 41 proceeds to step S138.

If it is determined that “3” is not included in the changing condition or that an input signal according to operating of any one of the push button switches is not input from the operating unit 44 (step S126; “NO”), the CPU 41 determines whether “4” is included in the changing condition and whether an input signal according to operating of the push button switch 1 is input from the operating unit 44 (step S127).

If it is determined that “4” is included in the changing condition and that an input signal according to operating of the push button switch 1 is input from the operating unit 44 (step S127; “YES”), processing of the CPU 41 proceeds to step S138.

If it is determined that “4” is not included in the changing condition or that an input signal according to operating of the push button switch 1 is not input from the operating unit 44 (step S127; “NO”), the CPU 41 determines whether “5” is included in the changing condition and whether the time set in the timer elapsed (time up) in the timer function which is executed (step S128).

If it is determined that “5” is included in the changing condition and that the time is up in the timer function (step S128; “YES”), processing of the CPU 41 proceeds to step S138.

If it is determined that “5” is not included in the changing condition or that the timer function is not executed or the time is not up in the timer function (step S128; “NO”), the CPU 41 determines whether “6” is included in the changing condition and whether the alarm set time, which is set and stored in the alarm setup storage unit 432, is reached (step S129).

If it is determined that “6” is included in the changing condition and that the alarm setup time is reached (step S129; “YES”), processing of the CPU 41 proceeds to step S138.

If it is determined that “6” is not included in the changing condition or that the alarm setup time is not yet reached (step S129; “NO”), the CPU 41 determines whether “7” is included in the changing condition and whether an input signal according to operating of the push button switch 2 is input from the operating unit 44 (step S130) as shown in FIG. 9.

If it is determined that “7” is included in the changing condition and that an input signal according to operating of the push button switch 2 is input from the operating unit 44 (step S130; “YES”), the CPU 41 moves up the set expiration timing by 1 hour (step S131).

Then, processing of the CPU 41 proceeds to step S136. If it is determined that “7” is not included in the changing condition or that an input signal according to operating of the push button switch 2 is not input from the operating unit 44 (step S130; “NO”), the CPU 41 determines whether “8” is included in the changing condition and whether an input signal according to operating of the push button switch 3 is input from the operating unit 44 (step S132).

If it is determined that “8” is included in the changing condition and that an input signal according to operating of the push button switch 3 is input from the operating unit 44 (step S132; “YES”), the CPU 41 extends the set expiration timing by 1 hour (step S133).

Then, processing of the CPU 44 proceeds to step S136.

it is determined that “8” is not included in the changing condition or that an input signal according to operating the push button switch 3 is not input from the operating unit 44 (step S132; “NO”), the CPU 41 determines whether “9” is included in the changing condition and whether an input signal according to operating of the push button switch 4 is input from the operating unit 44 (step S134).

If it is determined that “9” is included in the changing condition and that an input signal according to operating of the push button switch 4 is input from the operating unit 44 (step S134; “YES”), the CPU 41 changes the year display YYYY of the expiration timing to “9999” and cancels the setting of expiration timing (step S135).

Then, processing of the CPU 41 proceeds to step S137. If it is determined that “9” is not included in the changing condition or that operation of the push button switch 4 in the operating unit 44 is not detected (step S134; “NO”), processing of the CPU 41 proceeds to step S136.

When processing proceeds to step S136 from any one of steps S123, S131, S133 and S134, the CPU 41 determines whether the current date and time counted by the counter circuit 47 is before the expiration timing (step S136).

If it is determined that the current date and time is before the expiration timing (step S136; “YES”), processing of the CPU 41 proceeds to step S137.

On the other hand, if it is determined that the expiration timing is passed (step S136; “NO”), processing of the CPU 41 proceeds to step S138.

When processing proceeds to step S138 from the determination processes of steps S124 to S129 or the determination process of step S136, the CPU 41 changes the year display YYYY of the expiration timing to “0000” (step S138).

The CPU 41 further deletes the displayed message and returns to normal display (step S139). Then, the CPU 41 ends the display control process.

When processing proceeds to step S137 from the processes of steps S121, S135 and S136, the CPU 41 outputs a control signal to the display driver 46 and makes the display unit 45 perform displaying of a message (step S137).

Then, the CPU 41 ends the display control process. As described above, the information display system 1 according to Embodiment 1 of the present invention is configured with an electronic time piece 40 and a smartphone 10 between which sending and receiving of data can be performed through Bluetooth communication.

The electronic time piece 40 includes the Bluetooth module 48 for carrying out Bluetooth communication and the display unit 45. The smartphone 10 includes the Bluetooth module 24 for carrying out Bluetooth communication and the display setup data storage unit 142 provided in the storage unit 14 in which display setup data relating to a message to be displayed in the display unit 45 is stored.

The electronic time piece 40 receives display information based on the display setup information from the smartphone 10 and displays a message specified in the display information during a display period according to operation of the CPU 41.

Display period of a message is changed when a changing condition is fulfilled on the basis of changing condition included in the display information.

Therefore, in the electronic time piece 40, changing of display period according to circumstances can be set easily with no need of complicated operation for directly changing the setting of expiration timing, for example.

That is, a user can easily adjust the display period of a message which does not need to be displayed and a message which needs to be displayed longer than the set period.

Further, while management of display setup information can be performed all together in an external device such as the smartphone 10, simple operation for controlling the display period can be received at the electronic time piece 40 which is the display terminal as needed. Therefore, a message (display content) can be maintained to be in an appropriate state in a flexible manner.

Further, the changing conditions for changing the expiration timing of message display can be set so that such operation can be performed by only operating the operating unit 44 included in the electronic time piece 40, that is, by simple operation of the push button switches 1 to 4, a user can change the expiration timing with a simple operation suited for the electronic time piece 40 on which complex operation is difficult to perform.

By setting the patterns of changing of display period in the information display program 421 in advance, data amount relating to the display setup information and information relating to changing patterns to be included in the display information can be reduced and the setup can be exchanged in a simple manner.

Further, a plurality of changing conditions can be set and the expiration timing of the message display can be adjusted by only using the changing condition needed for each message among the plurality of changing conditions. Therefore, the adjustment process can be carried out flexibly for each message and not uniformly.

Not only in the case where the expiration timing is changed directly according to button operation by a user but also even in cases where the current time counted by the counter circuit 47 is changed and the home city stored in the home city storage unit 433 is changed wherein the expiration timing intentionally set at the time of set up of the expiration timing no longer has its meaning, the expiration timing is changed so that display is automatically ended. Therefore, burden on a user can be reduced and convenience of information viewing by a user can be improved.

Further, because display information relating to a message is not deleted directly from the display information storage unit 431 and is deleted through changing of the expiration timing, deletion of a message can be controlled in a simple manner through the same processing of changing expiration timing.

Because setting of display operation is performed in the smartphone 10 which is easy to operate and display operation itself is performed in the electronic time piece 40, which is a display terminal apparatus, that enables to view the display in various conditions, information can be acknowledged more surely and displaying can be controlled in an even simple and flexible manner by the display period being able to be changed simply through a simple operation also in the electronic time piece 40 which is the display terminal apparatus.

With respect to a display relating to arrival notification of a phone call or electronically transmitted message data (e-mail, SMS, text message) received in the smartphone 10, an arbitrary display period can be set for displaying and the display period can be changed easily according to what has arrived. Therefore, a user can acknowledge the needed arrival information in a surely and flexible manner without delay.

Further, by using a program for controlling the display period as described above, display period can be controlled in a simple manner in various display terminal apparatuses.

### Embodiment 2

Next, the information display system 1 according to Embodiment 2 will be described. Configuration of the information display system 1 according to Embodiment 2 and internal configurations of an electronic time piece 40 and a smartphone 10 constituting the information display system 1 are similar to the configuration in the information display system 1 according to Embodiment 1. Therefore, descriptions thereof are omitted.

Next, information display operation performed in the electronic time piece 40 according to Embodiment 2 will be described.

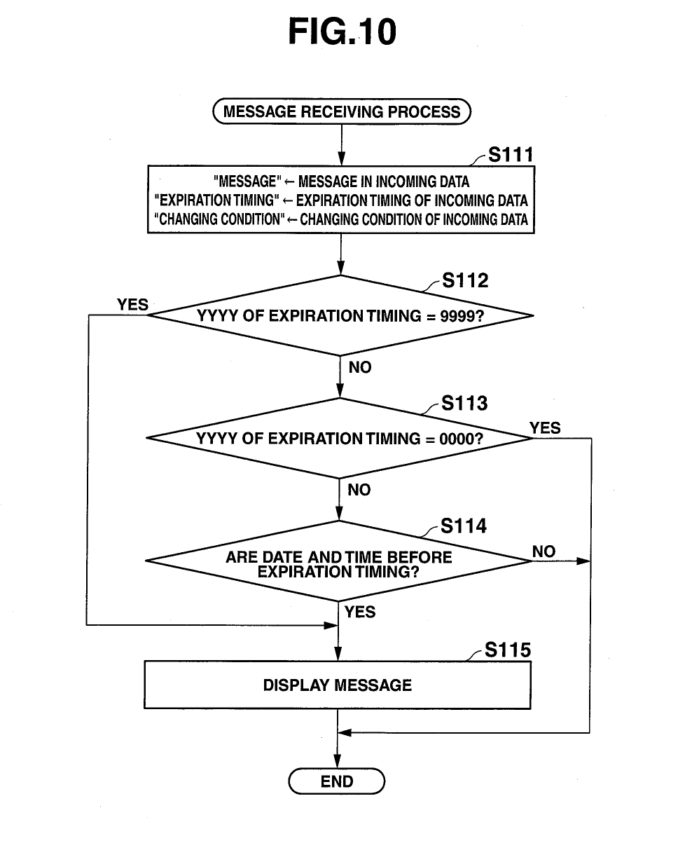

FIG. 10 is a flowchart showing a control procedure performed by the CPU 41 in the message receiving process executed in the electronic time piece 40 according to Embodiment 2.

The message receiving process is the same as the message receiving process executed in the electronic time piece 40 according to Embodiment 1 except for the point that step S116 is omitted. Therefore, like reference numerals are used for like aspects and their descriptions are omitted.

That is, in the message receiving process carried out in the electronic time piece 40 of Embodiment 2, even if it is determined that the current date and time is not before the expiration timing in the determination process of step S114, the CPU 41 ends the message receiving process there without changing the year display YYYY of the expiration timing to “0000” which indicates expiration.

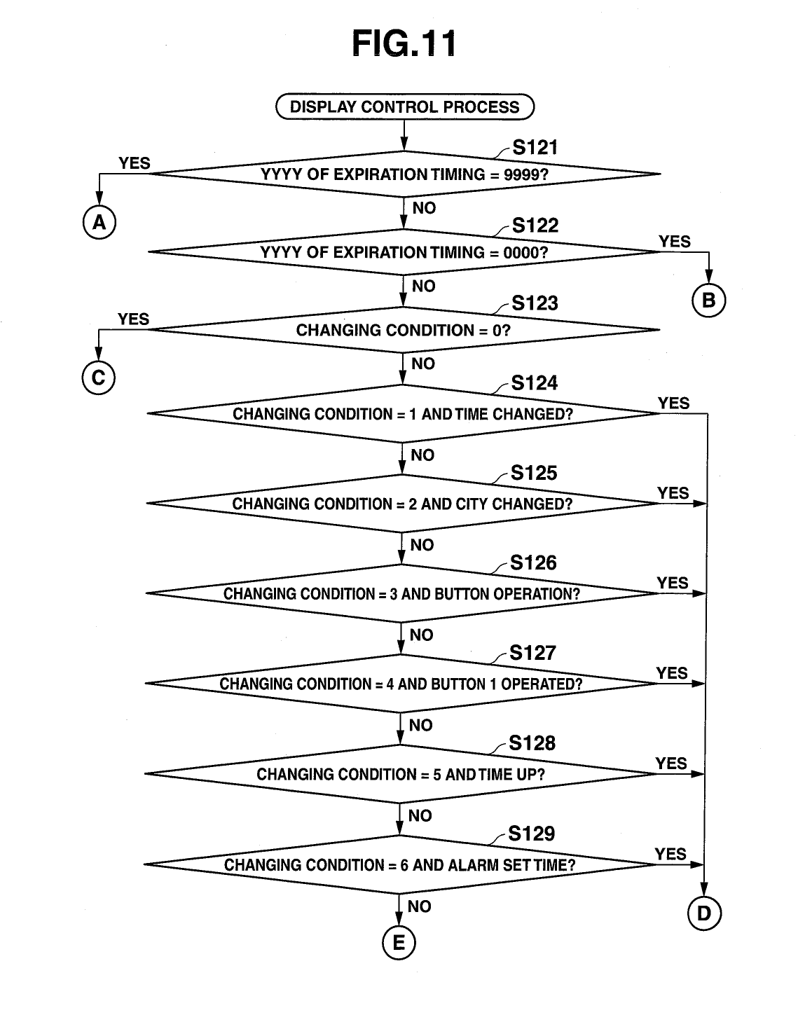

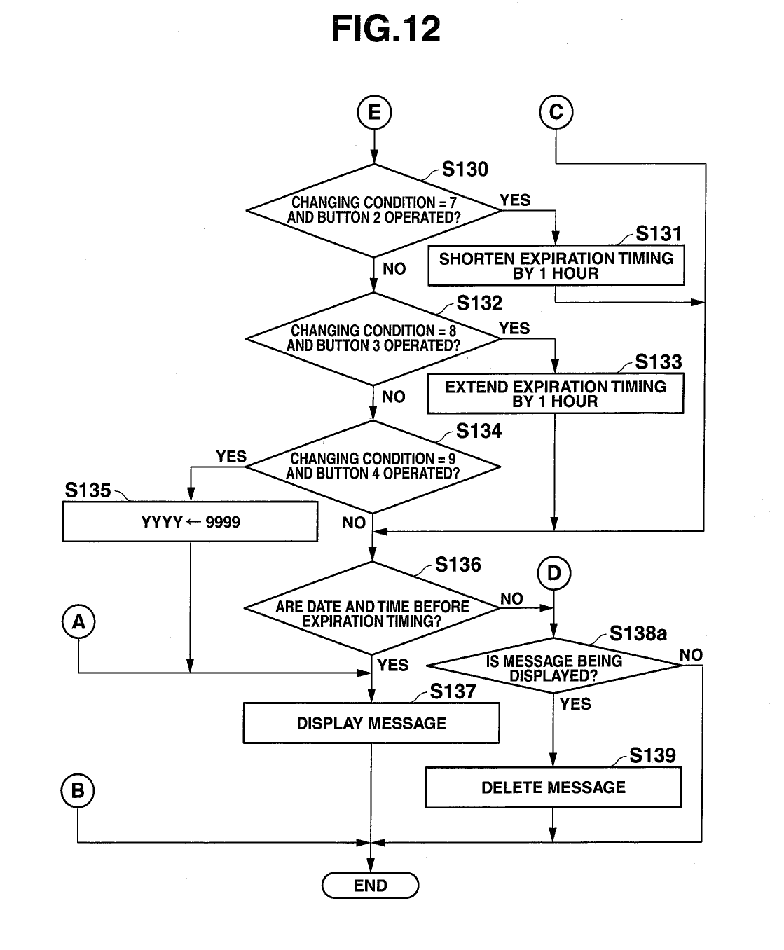

FIGS. 11 and 12 are flowcharts showing a control procedure performed by the CPU 41 in the display control process executed in the electronic time piece 40 of Embodiment 2.

The display control process is the same as the display control process executed in the electronic time piece 40 of Embodiment 1 except for the point that the process of step S138 is changed to the determination process of step S138a. Therefore, like reference numerals are used for like aspects and their descriptions are omitted.

That is, in the display control process carried out in the electronic time piece 40 of Embodiment 2, when processing proceeds to the determination process of step S138a from any of the processes of steps S124 to S129 and S136, the CPU 41 determines whether a message is being displayed currently (step S138a).

If it is determined that a message is being displayed (step S138a; “YES”), the CPU 41 deletes the message and returns the state to a normal display state (step S139).

If it is determined that a message is not being displayed (step S138a; “NO”), the CPU 41 ends the display control process with the current display state.

That is, also in the display control process, the year display YYYY of the expiration timing is not changed to “0000” which indicates expiration when the current time passed the expiration timing.

In such way, in the electronic time piece 40 of Embodiment 2, because the year display YYYY in the expiration timing setting of display information is not deleted and changed to “0000” for a message which is expired in the message receiving process and in the display control process, even if a message is once deleted from the display screen in the display unit 45, the display period can be extended easily and the display can reappear.

In such case, it is preferred to set so that the display information will not be deleted for a predetermined period of time after expiration with respect to a message which is expired.

By updating display information with new display information in the order from the display information which passed the predetermined time, the display unit 45 can perform an appropriate displaying without unnecessarily increasing the memory size of the display information storage unit 431 and while responding to reappearance of message display.

### Embodiment 3

Next, the information display system 1 according to Embodiment 3 will be described.

The information display system 1 of Embodiment 3 includes an electronic time piece 40a and a smartphone 10.

Inner configuration of the smartphone 10 is the same in the information display systems 1 of Embodiment 1 and Embodiment 3, therefore; the description will be omitted.

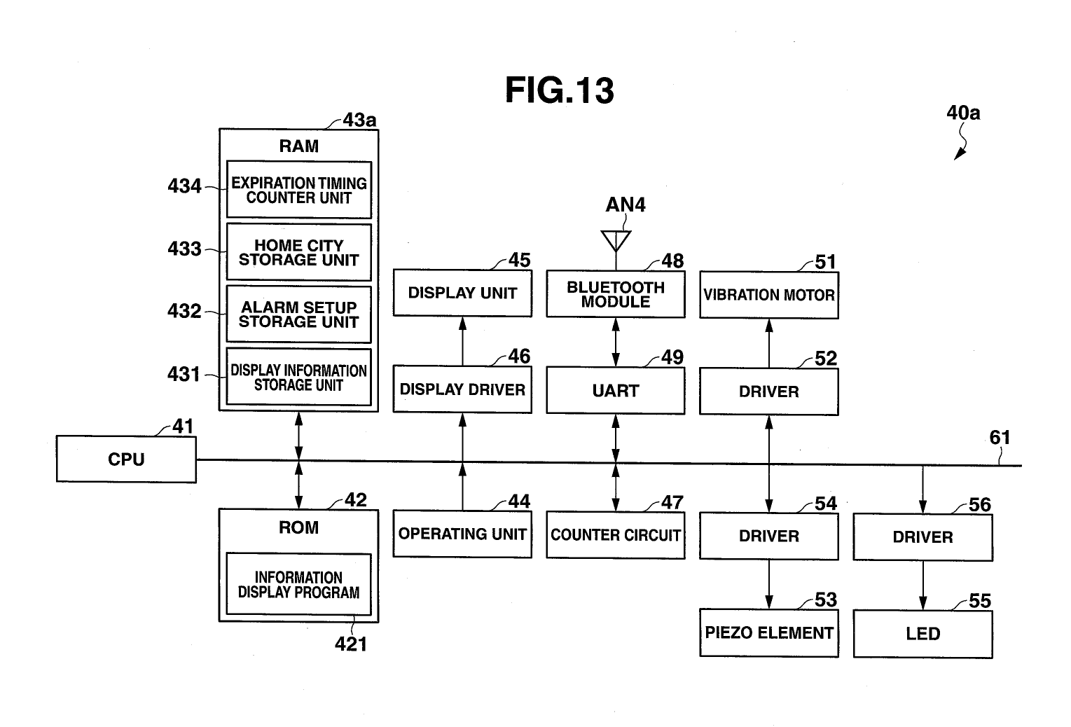

FIG. 13 is a block diagram showing an inner configuration of the electronic time piece 40a according to Embodiment 3.

The electronic time piece 40a is the same as the electronic time piece 40 except for the point that an expiration timing counter unit 434 (period counter unit) is included in the RAM 43a of the electronic time piece 40a. Therefore, like reference numerals are used for like aspects and their descriptions are omitted.

If display information is stored in the display information storage unit 431, the expiration timing counter unit 434 counts a value of the current time with respect to the expiration timing of the display information independently from the counter circuit 47 and stores the value.

That is, the current time stored in the expiration timing counter unit 434 is the time which is counted with the time when the display information was stored being the reference even if the current time counted by the counter circuit 47 is changed after the display information is stored in the display information storage unit 431.

Here, the expiration timing counter unit 434 may include a plurality of counter circuits individually as hardware components and not being provided in the RAM 43 in which the current time for assessing expiration timing counted in a software-based manner is to be stored.

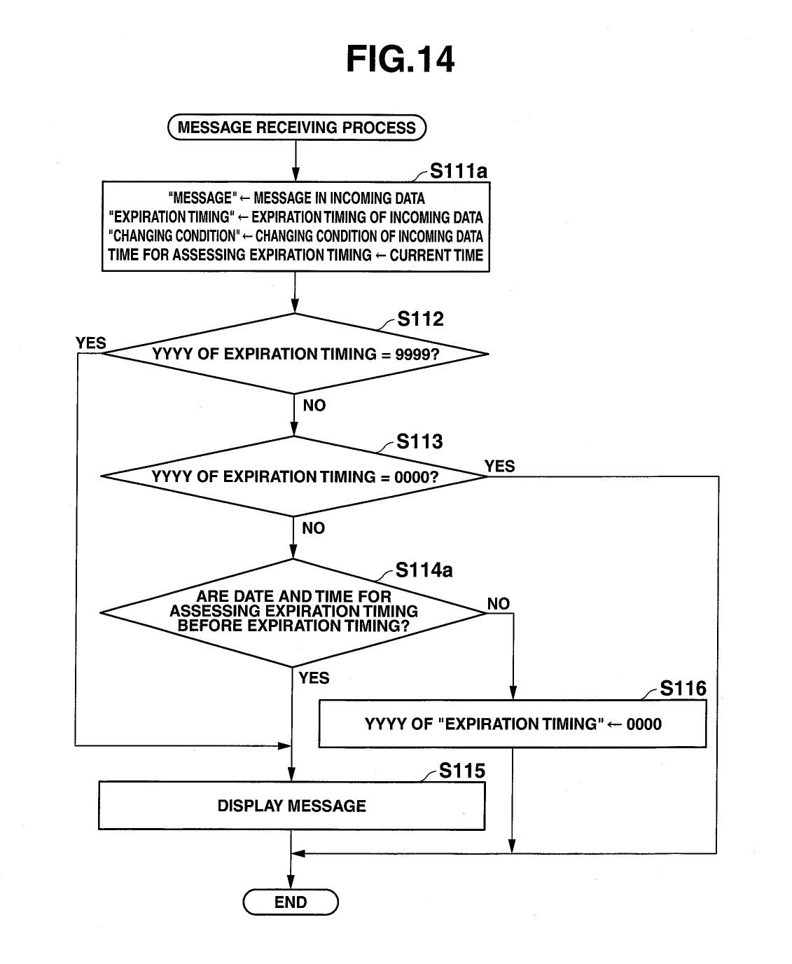

FIG. 14 is a flowchart showing a control procedure performed by the CPU 41 in the message receiving process executed in the electronic time piece 40a according to Embodiment 3.

The message receiving process is the same as the message receiving process executed in the electronic time piece 40 of Embodiment 1 except for the point that steps S111 and S114 in Embodiment 1 are changed to steps S111a and S114a. Therefore, like reference numerals are used for like aspects and their descriptions are omitted.

When the message receiving process starts, the CPU 41 stores a message relating to the received display information, the expiration timing and the changing condition in the display information storage unit 431, and also, copies the current time counted by the counter circuit 47 in the expiration timing counter unit 434 and starts counting the current time by setting the copied time as the reference (step S111a).

The current time for assessing expiration timing does not need to have the same level of accuracy as the current time counted by the counter circuit 47.

For example, if the set time of expiration stored in the display information storage unit 431 is in minutes, the configuration may be such that data of minutes and hours is updated one every minute.

When determining whether the current date and time is before the expiration timing in the process of step S114a, the CPU 41 uses the current time for assessing expiration timing stored in the expiration timing counter unit 434 as the current date and time.

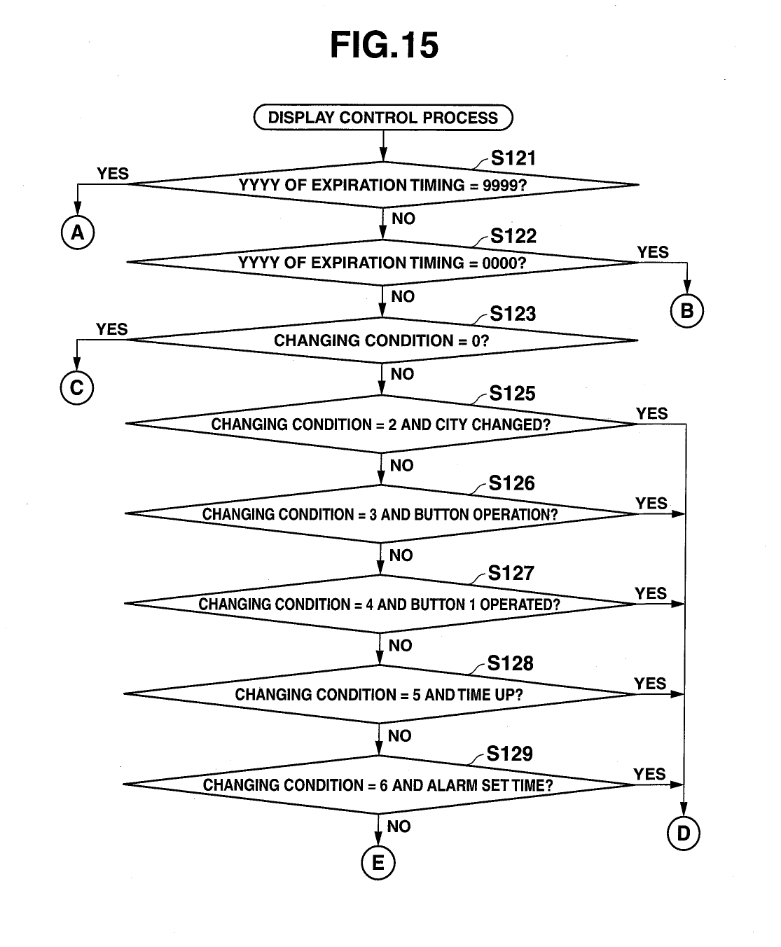

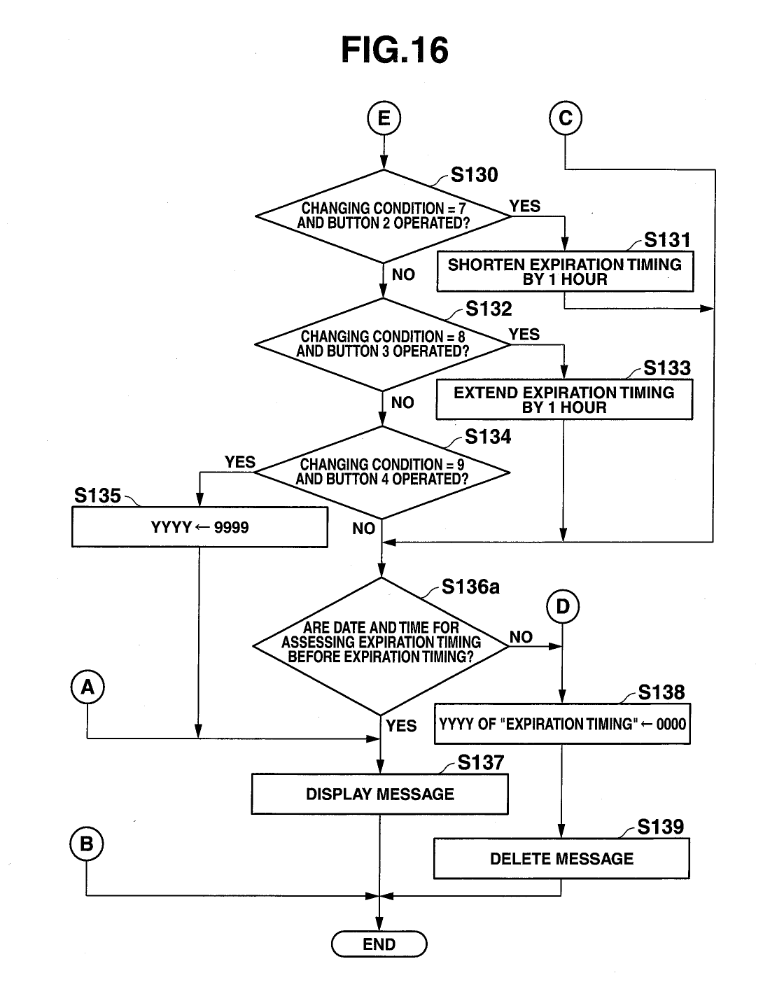

FIGS. 15 and 16 are flowcharts showing a control procedure performed by the CPU 41 in the display control process executed in the electronic time piece 40a of Embodiment 3.

The display control process of this embodiment is the same as the display control process executed in the electronic time piece 40 of Embodiment 1 except for the point that step S124 is omitted or the process of step S136 is changed to step S136a. Therefore, like reference numerals are used for like aspects and their descriptions are omitted.

In the display control process of this embodiment, processing proceeds to the determination process of step S125 if the arrow to “NO” is followed as a result of the determination process of step S123.

That is, the CPU 41 does not perform the determination process if the changing condition is “1”, therefore; the process of changing to “expired” is not performed even if the current time counted by the counter circuit 47 is changed.

When processing proceeds to step S136a from any of the processes of steps S123, S131, S133 and S134, the CPU 41 uses the current time for assessing expiration timing stored in the expiration timing counter unit 434 as the current date and time when determining whether the current date and time is before the expiration timing (step S136a).

That is, in the display control process, even if the current time counted by the counter circuit 47 is changed after the display information is stored in the display information storage unit 431 in the message receiving process, the time counted with the time when the display information was stored being the reference is compared to the expiration timing.

In such way, the electronic time piece 40a of Embodiment 3 includes the expiration timing counter unit 434.

When display information is received from the smartphone 10, the current time for assessing expiration timing for setting the expiration timing of the message is counted by copying the current time in the counter circuit 47 at this timing.

Therefore, regardless of the gap between the current time and the original time due to setting change and correction of the current time in the electronic time piece 40a, a message can be displayed in the display unit 45 during the time period corresponding to the elapsed time till the expiration timing, which a user desires, determined at the setting.

Especially, even in a case where the current time counted by the counter circuit 47 is changed after display of a message started, the expiration timing is determined and the display period is set by the time obtained on the basis of the time intended at the setting in the smartphone 10 remaining to be the reference. Therefore, deletion of message display at an unintended timing due to changing of the current time and excess extension of message display can be prevented.

Here, the present invention is not limited to the above embodiments and various changes can be made.

For example, in the above embodiments, configurations where one display screen for time display is shared as the display unit 17 are described. However the electronic time piece 40 may include a display screen for information display separately.

The electronic time piece 40 is not limited to a plain digital electronic time piece and may be a time piece in which analog display using hands is also performed. Moreover, according to the content to be displayed, the electronic time piece 40 may be an electronic time piece which only performs analog display.

The display terminal apparatus is not limited to the electronic time piece 40.

Ina case where a smartphone or a mobile phone other than the smartphone 10 is to be used together, the display terminal apparatus may be these communication devices or may be a portable devices including an electronic pedometer and other devices which are to be worn around an arm.

On the other hand, an external device is not limited to the smartphone 10 and a mobile phone, a PDA (Personal Digital Assistant), a tablet terminal or the like may be sued. Further, an external device may include a computer or an information device which is set inside a room.

In the above embodiments, Bluetooth communication is suggested as an example of wireless communication. However, other methods such as by using UWB (Ultra Wide Band), ZIGBEE (registered trademark) or Wi-Fi can be adopted.

Further, in the above embodiments, examples where display information stored in the display information storage unit 431 is updated by rewriting the information which is expired, from the oldest ones, with new information in a uniform manner are shown. However, other methods may be adopted.

For example, it may be set so as to rewrite the same information if display information relating to the same information name is received.

By setting in such way, display information can be updated efficiently before expiration.

Furthermore, in the above embodiments, display information is sent to the electronic time piece 40 from the smartphone 10 at the start and its display is started right away. However, configuration may be such that display information is sent to the electronic time piece 40 at the time of setup or a predetermined time period earlier than the display start.

By adopting such configuration, display can be started for sure even if the Bluetooth communication is temporarily cutoff at the timing of display start is set.

Moreover, in the above embodiments, changing of expiration timing according to operation of a push button switch or the like is described. However, setting may be such that the expiration timing is changed without a user's operation but on the basis of a changing condition based on cutting off of Bluetooth communication or a changing condition based on a measurement value obtained from a measurement sensor such as an acceleration sensor or a temperature sensor.

Further, examples such as no expiration timing, expired, 1 hour extension/moving up by 1 hour are suggested as variation for changing of display period. However, these examples are not limitative in any way.

Other types of time extension and moving up can be set within the range the required operation in the electronic time piece 40 does not become complicated.

It may be set that “no setting of expiration timing” and “expired” are not to be set.

Alternatively, changing of the setting to “expired” may be performed by changing the year display YYYY to the current time and not by changing to “0000”.

As for the setting method of the changing operation, it can be set arbitrarily.

In the above embodiments, setting of changing conditions that is on the basis of pushing of push button switches 1 to 4 in the electronic time piece 40 are described. However, the changing operating can be set arbitrarily according to the number of push button switches and whether a crown is included or not.

Further, in the above embodiments, setting of association between a changing condition and operation relating to the changing condition is included in the display setup program 141 and the information display program 421. However, the configuration may be such that a setup table which is to be read in these programs is prepared separately. Here, the setup table can be prepared and changed in the smartphone 10 according to the configuration of the electronic time piece 40.

Furthermore, in the above embodiments, the time of expiration timing is set and stored. However, the time of expiration timing may be expressed in relative elapsed time (display duration time).

For example, the display period may be controlled by setting the expiration timing in time, calculating the display duration time up to the set time, storing the calculated duration time in the display information storage unit 431 and counting.

In the above embodiments, the current time for assessing expiration timing is counted separately and stored in the expiration timing counter unit 434. However, in a case where the current time in the counter circuit 47 is changed, the display period of a message can be controlled on the basis of the time before the current time is changed by storing the time difference between the time before the change and the time after the change and by reading the expiration timing taking the difference in to consideration.

Further, in the above embodiments, examples where the ROM 42 and the storage unit 14 formed of a non-volatile memory are used as computer readable medium for storing the programs according to the present invention. However, these examples are not limitative in any way.

As other computer readable mediums, portable type recording mediums such as CD-ROMs and USB memories can be used.

As a medium for providing data of programs according to the present invention via a communication circuit, carrier wave can be applied to the present invention.

Details such as specific numeral values, configurations and the order of processes described in the above embodiments can be changed arbitrarily within the scope of the present invention.

Several embodiments of the present invention are described above. However, the scope of the present invention is not limited to the above described embodiments and includes the scope of the invention described in claims and equivalents thereof.

What is claimed is:

1. A display terminal apparatus, comprising:
a wireless communication unit for performing wireless communication with a set external device;
a display unit;
a display information obtaining unit which obtains display information including a display content to be displayed in the display unit, a display period setting of the display content and a changing condition for changing the display period through the wireless communication unit;
a display control unit which controls the display period of the display content in the display unit on the basis of the display period setting;
a determination unit which determines whether a state corresponds to the changing condition; and
a display period changing unit which changes the display period on the basis of a determination result obtained in the determination unit.

2. The display terminal apparatus according to claim 1 further comprises an operating unit which receives input operation, wherein
the determination unit determines whether operation corresponding to the changing condition is received in the operating unit.

3. The display terminal apparatus according to claim 1, wherein
the determination unit determines whether the state corresponds to any one of a plurality of changing conditions, and
the display period changing unit changes the display period according to a changing content set in advance corresponding to each changing condition.

4. The display terminal apparatus according to claim 1 further comprises a counter unit which counts a current date and time, wherein
the determination unit determines whether the current date and time, which is counted by the counter unit, is corrected by a predetermined time period or more during the display period of the display content, and
the display period changing unit changes the display period so as to end the display period of the display content when it is determined that the current date and time is corrected by the predetermined time period or more by the determination unit.

5. The display terminal apparatus according to claim 1 further comprises:
a counter unit which counts a current date and time, and
a period counter unit which counts an elapsed time relating to the display period of the display content,
wherein
the display control unit controls the display period of the display content according to the elapsed time counted by the period counter unit.

6. The display terminal apparatus according to claim 5, wherein
the period counter unit counts the current date and time by setting the date and time counted by the counter unit as a reference at a timing when the display content is obtained through the wireless communication unit.

7. The display terminal apparatus according to claim 1 further comprises a storage unit in which a predetermined number of display information is stored,
wherein the display information obtaining unit updates the display information relating to the display content, which a predetermined time period elapsed after the display period ended, by rewriting the display information with display information newly obtained.

8. An information display system, comprises:
a display terminal apparatus, and
an external device,
wherein
the display terminal apparatus includes a wireless communication unit for performing wireless communication with a set external device, a display unit, a display information obtaining unit which obtains display information including a display content to be displayed in the display unit, a display period setting of the display content and a changing condition for changing the display period through the wireless communication unit, a display control unit which controls the display period of the display content in the display unit on the basis of the display period setting, a determination unit which determines whether a state corresponds to the changing condition, and a display period changing unit which changes the display period on the basis of a determination result obtained in the determination unit, and
the external device includes an external wireless communication unit for performing wireless communication with another external device, an external setting unit for setting display setup information including the display content to be displayed in the display terminal apparatus, the display period of the display content and the changing condition for changing the display period, an external storage unit in which the display setup information is stored for each display content, and a display information control unit which makes the external wireless communication unit send the display information relating to the display content to the display terminal apparatus at a predetermined timing with display start date and time of the display content being a reference.

9. The information display system according to claim 8, wherein
the external device includes a second communication unit for telephone and/or for performing sending and receiving of electronically transmitted message data, and
when the telephone and/or the electronically transmitted message data arrived through the second communication unit, the external setting unit sets the display setup information including a display content indicating the arrival and the display period which is a predetermined time period from a timing of the arrival.

10. An information display control method for displaying a display content obtained from a set external device in a display terminal apparatus including a wireless communication unit for performing wireless communication with the external device, comprising:
obtaining display information including a display content to be displayed, a display period setting of the display content and a changing condition for changing the display period through the wireless communication unit;
controlling the display period of the display content on a basis of the display period setting;
determining whether a state corresponds to the changing condition; and
changing the display period on a basis of a determination result obtained in the determining.

11. A non-transitory computer readable storage medium storing a program which makes a computer used in a display terminal apparatus which displays a display content obtained from a set external device, the display terminal apparatus including a wireless communication unit for performing wireless communication with the external device, function as:
a display information obtaining unit which obtains display information including a display content to be displayed, a display period setting of the display content and a changing condition for changing the display period through the wireless communication unit;
a display control unit which controls the display period of the display content on a basis of the display period setting;
a determination unit which determines whether a state corresponds to the changing condition; and
a display period changing unit which changes the display period on a basis of a determination result obtained in the determination unit.
